(19) United States
(12) Patent Application Publication
(10) Pub. No.: US 2008/0309291 A1
(43) Pub. Date: Dec. 18, 2008

(54) COMPUTER SYSTEM AND CONTROL METHOD THEREOF

(75) Inventor: Jae-deok CHA, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/042,397

(22) Filed: Mar. 5, 2008

(30) Foreign Application Priority Data
Jun. 13, 2007 (KR) 2007-57890

(51) Int. Cl. H02J 7/00

(52) U.S. Cl. 320/139; 320/160

(57) ABSTRACT

A computer system, including a converter to convert a level of an input voltage into a charging voltage and to output the charging voltage to a battery unit; a converter driving unit to output a driving signal to the converter so that the charging voltage outputted from the converter is able to reach a predetermined target value; and a controller to control the converter driving unit to alternate the driving signal between supplying the charging voltage and suspension of the charging voltage.

### CROSS-REFERENCE TO RELATED APPLICATION

This application claims all benefits accruing under 35 U.S.C. §119 from Korean Patent Application No. 2007-57890, filed in the Korean Intellectual Property Office on Jun. 13, 2007, the disclosure of which is incorporated herein by reference.

### BACKGROUND OF THE INVENTION

1. Field of the Invention

Aspects of the present invention relate to a computer system and a control method thereof, and more particularly, to a computer system using a chargeable battery as a power supply, and a control method thereof.

2. Related Art

If a computer system, such as a notebook computer, cannot be powered by an external power source, for example, in situations where the user of the computer system needs to be on the move, the computer system uses a battery as an auxiliary power supply. The battery is chargeable, and the computer system can charge the battery using the external power source.

A constant current constant voltage (CCCV) method is a conventional method of charging a battery. As shown in FIG. 1, the CCCV method may be divided into two charging modes, a constant current (CC) mode and a constant voltage (CV) mode.

In the CC mode, a charging current 1 remains constant while a charging voltage 2 is increasing. In the CV mode, the charging voltage 2 remains constant while the charging current 1 is decreasing. Although the CCCV method has excellent stability, longer charging times are required for higher capacity batteries.

An alternative charging method is a pulse charging method. In the pulse charging method, as shown in FIG. 2, when a charging voltage 4 reaches a predetermined target value V_{CHG}, supply of charging current 3 is temporarily suspended. Thereafter, the battery is discharged due to minute, internal power consumption of the battery. When the charging voltage 4 decreases to a predetermined value V_{CE} according to this discharging, the supply of charging current 3 restarts. In this manner, the pulse charging method shortens charging time by alternating the charging current 3 between supply of the charging current 3 and suspension of the charging current 3, that is, applying the charging current 3 in the form of a pulse, to charge the battery.

The pulsed charging current 3 results from repeated connection and disconnection of the battery, as a load, to and from a charging circuit. In the pulse charging method, the battery is charged by turning on/off a switching device, such as a metal-oxide-semiconductor field effect transistor (MOSFET), provided on a supply path of the charging current 3. Since the supply path of the charging current 3 is repeatedly disconnected and connected, there is a high possibility of voltage overshoot, which has an adverse effect on stability of the battery, resulting in deterioration of the battery's durability.

In addition, in such a pulse charging system, the switching device may often be provided within the battery. In this case, in order to protect the battery against an excessive charging voltage, the switching device is designed to be turned off to stop charging if the charging voltage exceeds a predetermined threshold value. Accordingly, the pulse charging method is limited in that the charging voltage is set to be higher than a cell voltage of the battery in order to intentionally turn off the switching device provided within the battery. In addition, since a duty ratio of the charging pulse depends on the cell voltage of the battery, it is not possible to design the duty ratio dynamically.

Moreover, in the conventional battery charging techniques, since it is impossible to change from one charging method to another charging method, selection of a proper charging method according to the situation is not possible.

### SUMMARY OF THE INVENTION

Accordingly, aspects of the present invention provide a computer system capable of charging a battery with high stability and preventing durability of the battery from being deteriorated, and a control method thereof.

Another aspect of the present invention is to provide a computer system that employs a battery charging system capable of being dynamically designed, and a control method thereof.

Still another aspect of the present invention is to provide a computer system capable of selecting a proper battery charging system according to situations.

Additional aspects of the present invention will be set forth in part in the description which follows and, in part, will be obvious from the description, or may be learned by practice of the present invention.

According to an aspect of the invention, a power supply apparatus is provided. The apparatus includes a converter to convert a level of an input voltage into a charging voltage and to output the charging voltage to a battery unit that supplies power to the computer system; a converter driving unit to output a driving signal to the converter so that the charging voltage outputted from the converter is able to reach a predetermined target value; and a controller to controls the converter driving unit to alternate the driving signal between supplying the charging voltage and suspension of the charging voltage.

According to another aspect of the invention, the controller controls the converter driving unit to alternate the driving signal between supply and suspension after the charging voltage of the battery unit has reached the predetermined target value.

According to another aspect of the invention, the converter converts a level of an input direct current (DC) voltage according to a switch-mode method, and the driving signal of the converter driving unit includes a Pulse Width Modulation (PWM) signal.

According to another aspect of the invention, the converter driving unit and the controller are integrally formed.

According to another aspect of the invention, the charging voltage outputted from the converter has the same level as a cell voltage of the battery unit.

According to another aspect of the invention, the controller selectively performs a first control operation to alternate the driving signal between supplying and suspension and a second control operation to maintain output of the driving signal.

According to another aspect of the invention, the computer system further includes a user input unit to input an instruction from a user, wherein one of the first control operation and the second control operation is determined according to the instruction from the user.

According to another aspect of the invention, the battery unit is provided in a computer system.

According to another aspect of the invention a control method of a computer system including a converter to convert a level of an input voltage into a charging voltage and to output the charging voltage to a battery unit, and a converter driving unit to output a driving signal to the converter so that the charging voltage outputted from the converter is able to reach a predetermined target value is provided. The control method includes controlling the converter driving unit to alternate the driving signal output by the converter driving unit between supplying the charging voltage and suspension of the charging voltage.

According to another aspect of the invention, the driving signal is alternated after the charging voltage of the battery unit has reached the target value.

According to another aspect of the invention, the converter driving unit is controlled by selectively performing a first control operation to alternate the driving signal between supply and suspension and a second control operation to maintain output of the driving signal.

According to another aspect of the invention, the selectively performing the first control operation and the second control operation include: receiving an instruction from a user; and selecting one of the first control operation and the second control operation according to the instruction from the user.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 shows a battery charging profile in a conventional CCCV method;

FIG. 2 shows a battery charging profile in a conventional pulse charging method;

FIG. 3 is a block diagram showing a configuration of a computer system according to an example embodiment of the invention;

FIG. 4 is a block diagram showing a configuration of a power supply unit according to an example embodiment of the invention; and

FIG. 5 is a flow chart showing a charging process of a battery in the computer system according to an example embodiment of the invention.

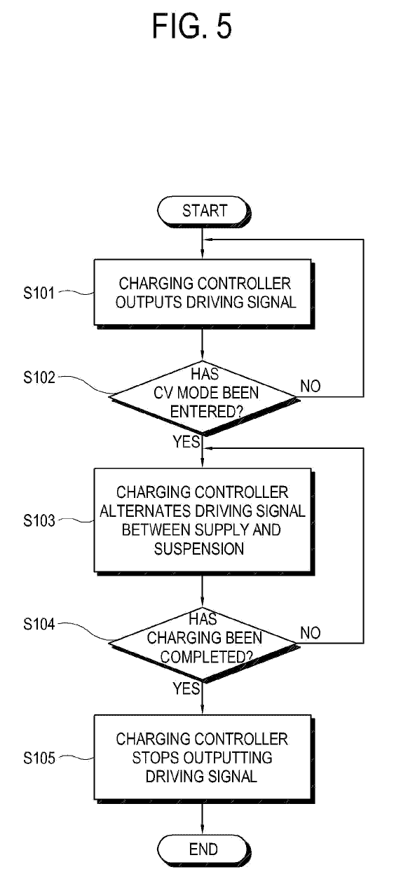

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

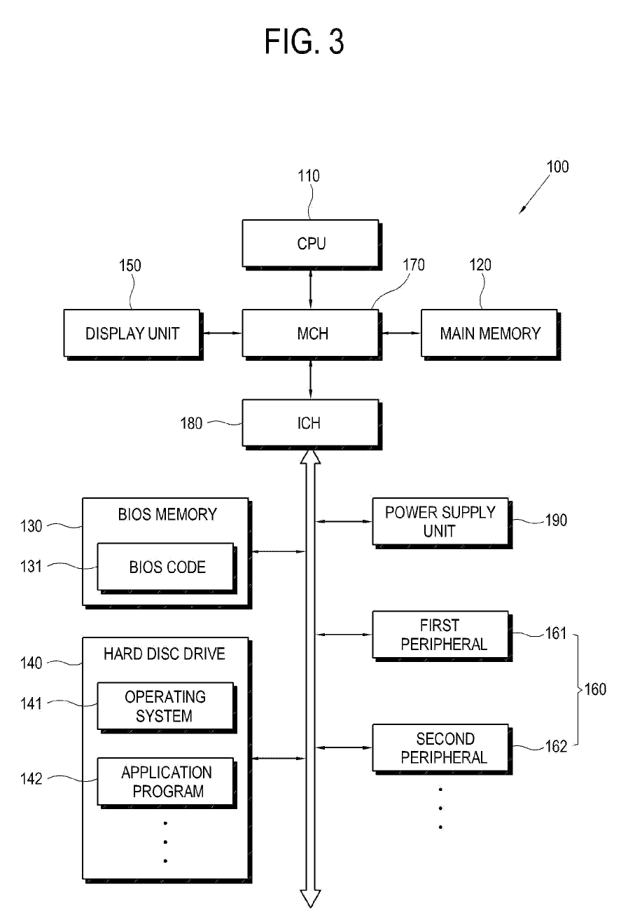

FIG. 3 is a block diagram showing a configuration of a computer system 100 according to an example embodiment of the invention. The computer system 100 includes a central processing unit (CPU) 110, a main memory 120, a Basic Input/Output System (BIOS) memory 130, a hard disc drive 140, a display unit 150, peripherals 160, a Memory Control Hub (MCH) 170, an I/O Control Hub (ICH) 180 and a power supply unit 190. According to other aspects of the invention, the computer system 100 may include additional and/or different units. Similarly, the functionality of two or more of the above units may be combined into a single component. The computer system 100 may be any computing device, such as a desktop, a laptop, a personal digital assistant (PDA), a personal entertainment device, or a mobile phone.

The CPU 110, which controls the whole operation of the computer system 100, executes codes loaded in the main memory 120 and executes instructions corresponding to the codes. In executing the instructions, the CPU 110 communicates with and controls the hard disc drive 140, the display unit 150, the peripherals 160, the MCH 170, the ICH 180 and the power supply unit 190.

The main memory 120 temporarily stores codes executed by the CPU 110 and data related to performance of the CPU 110. The main memory 120 may be embodied by a volatile memory, for example, a double-data-rate synchronous dynamic random access memory (DDR SDRAM) or the like.

A BIOS code 131 is stored in the BIOS memory 130. When the computer system 100 is booted, the BIOS code 131 is loaded into the main memory 120 to cause the CPU 110 to initialize the computer system 100. In addition, if an interrupt, such as System Management Interrupt (SMI), occurs during operation of the CPU 110, instruction codes required for such situation may be pre-stored in the BIOS memory 130. The BIOS memory 130 may be embodied by a non-volatile memory, for example, a programmable read-only memory (PROM), an erasable programmable read-only memory (EPROM), an electrically erasable and programmable read-only memory (EEPROM), a flash memory, or other memories.

The hard disc drive 140 is a mass storage device in which an operating system (OS) 141, application programs 142, and other data are stored. The operating system 141 includes programs and data required for general operation of the computer system 100. For example, the operating system (OS) 141 may be Microsoft Windows, Linux, Mac OS X, or other operating system. The application programs 142 are programs to cause the computer system 100 to execute particular functions in conjunction with the operating system (OS) 141. All or some of the operating system (OS) 141 and the application programs 142 can be loaded into the main memory 120 and are executed by the CPU 110.

The display unit 150 displays the operation of the computer system 100 to the user and may include a graphic processor, such as a graphics card, and a display module, such as an LCD monitor. The peripherals 160 are hardware to cause the computer system 100 to perform various functions and may include a plurality of devices, for example, a first peripheral 161 and a second peripheral 162, as shown in FIG. 3.

Each of the first peripheral 161 and the second peripheral 162 may be a user input device, such as a keyboard, a mouse, a tablet, a touch screen, or a joystick; an image input device, such as a Webcam, an image scanner, or a barcode reader; a sound output device, such as a sound card, a speaker; a sound input device, such as a microphone; an image forming apparatus, such as a printer, a facsimile machine, or a multifunction device; a storage device, such as a CD-ROM, a CD-R, a CD-RW, a DVD-ROM, a DVD-R, a DVD-RW, or a USB drive (USB flash drive); and a communication device, such as a modem or a network card.

The MCH 170 and the ICH 180 interface data communication between the CPU 110 and other devices, as shown in FIG. 3. The MCH 170 is provided for high speed communication, while the ICH 180 is provided for low speed communication. The MCH 170 and the ICH 180 may be integrated into a single chipset, or remain as separate chipsets.

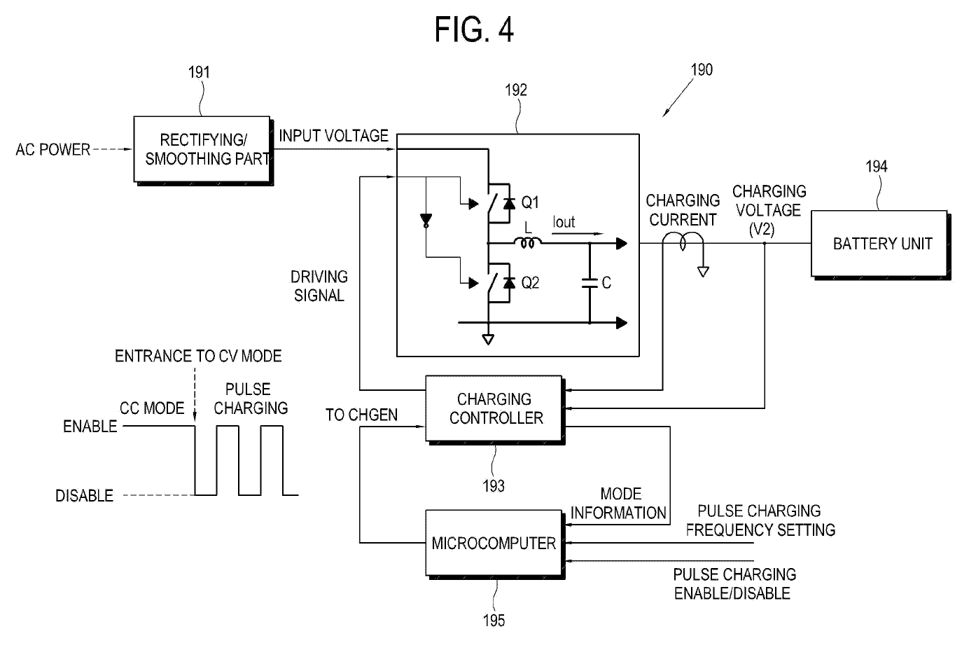

The power supply unit 190 supplies the CPU 110 and other devices with power required for operation. FIG. 4 is a block diagram showing a configuration of the power supply unit 190 according to an example embodiment of the invention. In FIGS. 3 and 4, power supply paths to the CPU 100 and other devices are omitted for the sake of convenience.

The power supply unit 190 includes a rectifying/smoothing part 191, a synchronous buck 192, and a charging controller 193. The rectifying/smoothing part 191 receives AC power from an external power source and rectifies and smoothes the received AC power to output an input voltage V1.

The synchronous buck 192 receives the input voltage V1 from the rectifying/smoothing part 191 and converts a level of the input voltage V1 to output a charging voltage V2. The charging controller 193 controls the synchronous buck 192 so that the charging voltage V2 outputted from the synchronous buck 192 is able to reach a predetermined target value. The synchronous buck 192 and the charging controller 193 are provided as examples of a converter and a converter driver. The charging voltage V2 outputted from the synchronous buck 192 may be supplied as operating power of the devices. In addition, the charging voltage V2 outputted from the synchronous buck 192 may be supplied to a battery 194 to charge the battery 194, as shown in FIG. 4.

The battery 194 is an example of a battery unit. The battery 194 supplies auxiliary power if the AC power is not supplied or the charging voltage V2 outputted from the synchronous buck 192 is abnormal. The battery 194 includes at least one rechargeable battery cell (not shown). The battery cell may be one of a nickel-cadmium (Ni—Cd) cell, a lithium-ion (Li-ion) cell, a nickel metal hybrid (Ni-MH) cell, and other cells known in the art. The battery 194 may be detachably connected to the power supply unit 190.

The synchronous buck 192 is provided as a DC-DC converter that performs switch-mode conversion to convert the input voltage V1 to the output voltage V2. As shown in FIG. 4, the synchronous buck 192 includes a first FET Q1, a second FET Q2, an inductor L, and a capacitor C. The first FET Q1 and the second FET Q2 are turned on and off depending on an input driving signal. The driving signal may be a pulse width modulation (PWM) signal and is generated and supplied by the charging controller 193.

If the driving signal outputted from the charging controller 193 is inputted to the synchronous buck 192, driving signals having different logic states are inputted to gates of the first FET Q1 and the second FET Q2, respectively. If one of the first FET Q1 and the second FET Q2 is turned on, the other is turned off. If the driving signal is not outputted from the charging controller 193, and accordingly, the driving signal is not inputted to the synchronous buck 192, both of the first FET Q1 and the second FET Q2 are turned off.

If the first FET Q1 is turned on and the second FET Q2 is turned off, the input voltage V1 is applied to the inductor L, and current lout flows. Energy is stored in the inductor L, and the charging voltage V2 rises while the input voltage V1 is being supplied. If the first FET Q1 is turned off and the second FET Q2 is turned on, the current lout flows by the energy stored in the inductor L. In this case, since the input voltage V1 is interrupted, the charging voltage V2 decreases. If both of the first FET Q1 and the second FET Q2 are turned off, the current lout does not flow. In this case, the charging voltage V2 is not suddenly changed by the capacitor C, but is slowly decreased by internal discharging of the battery 194.

The charging controller 193 monitors the charging voltage V2 and adjusts a duty ratio of a PWM signal as the driving signal so that the charging voltage V2 can reach the predetermined target value. The target value of the charging voltage V2 corresponds to a voltage of the battery cell of the battery 194. For example, if two battery cells are included in the battery 194 and each battery cell is 4.2 volts, the target value of the charging voltage V2 may be 8.4 volts.

As shown in FIG. 4, the power supply unit 190 further includes a microcomputer 195. The microcomputer 195 controls the general charging process of the battery 194 by controlling the operation of the charging controller 193. The microcomputer 195 may control the charging process of the battery 194 according to one of two charging methods, a CCCV method and a pseudo pulse charging method.

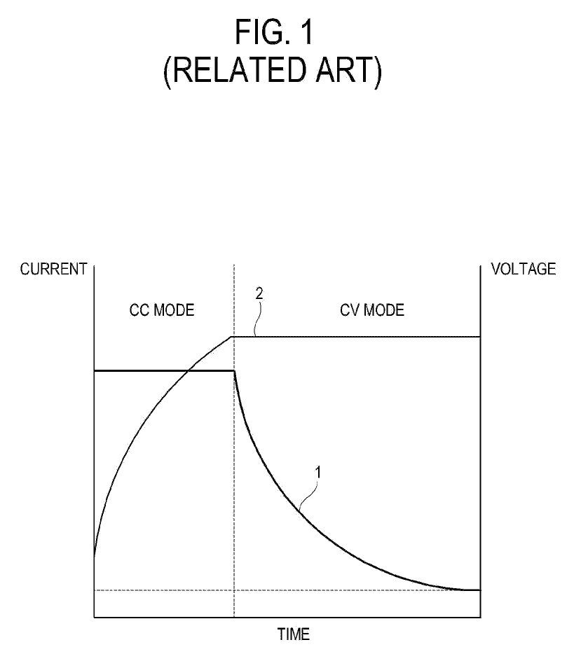

If the CCCV method is selected, the microcomputer 195 controls the charging controller 193 to continue to output the driving signal without stopping the output of the driving signal. In this case, as in the CC mode shown in FIG. 1, the charging controller 193 adjusts the driving signal so that the charging voltage V2 increases until the charging voltage V2 reaches the predetermined target value. After the charging voltage V2 reaches the predetermined target value, the charging controller 193 adjusts the driving signal so that the charging voltage V2 remains constant, as in the CV mode shown in FIG. 1.

The charging controller 193 may be embodied by a chipset and has an ENABLE state in which the driving signal is outputted to the synchronous buck 192, and a DISABLE state in which the driving signal is not outputted to the synchronous buck 192. The charging controller 193 includes a signal input pin CHGEN to cause the charging controller 193 to operate in one of the ENABLE state and the DISABLE state by an external input signal.

In order to make the charging controller 193 perform an output operation of the driving signal, the microcomputer 195 transmits an ENABLE signal to the signal input pin CHGEN of the charging controller 193. The ENABLE signal may be, for example, a high level signal. When the ENABLE signal is inputted to the charging controller 193 through the signal input pin CHGEN, the charging controller 193 continues to output the driving signal to the synchronous buck 192 until a DISABLE signal is inputted to the charging controller 193. While the driving signal is being inputted from the charging controller 193 to the synchronous buck 192, the battery 194 is charged according to the CCCV method.

If the pseudo pulse charging method is selected, the microcomputer 195 controls the charging controller 193 to alternate the driving signal between supply (supplying the charging signal) and suspension (not supplying the charging signal). The microcomputer 195 controls the charging controller 193 to repeatedly output the driving signal in one time interval and suspend the driving signal in another time interval. During the time interval in which the charging controller 193 suspends the driving signal, the driving signal is not inputted from the charging controller 193 to the synchronous buck 192.

If the battery 194 is to be charged according to the pseudo pulse charging method, the microcomputer 195 transmits the ENABLE signal and the DISABLE signal alternately to the signal input pin CHGEN of the charging controller 193. The DISABLE signal may be, for example, a low level signal.

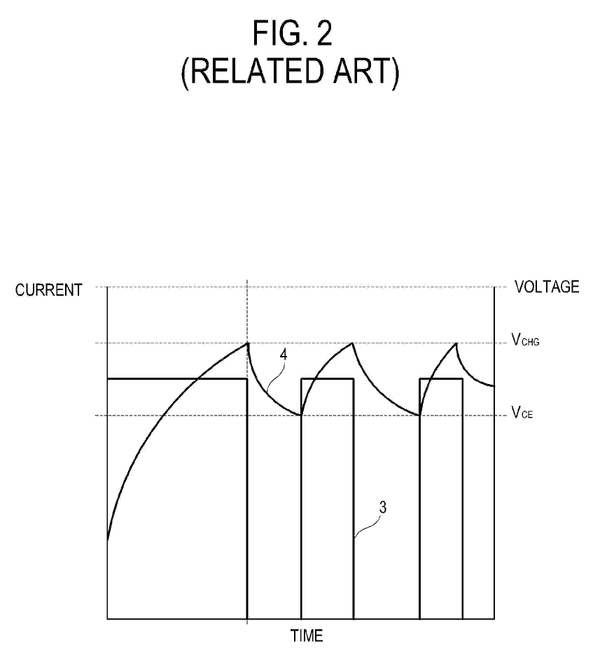

Of the above time intervals in which the driving signal is repeatedly outputted and suspended, during the time interval in which the driving signal is outputted to the synchronous buck 192, the synchronous buck 192 and the charging controller 193 operate in the same way as the CCCV method. The charging controller 193 adjusts and outputs the driving signal so that the charging voltage V2 outputted from the synchronous buck 192 reaches the predetermined target value. Accordingly, during this time interval, the charging voltage V2 outputted from the synchronous buck 192 increases to the predetermined target value, as shown in FIG. 2.

During the time interval in which the driving signal is not outputted from the charging controller 193 to the synchronous buck 192, both of the first FET Q1 and the second FET Q2 of the synchronous buck 192 are turned off, as described above. Accordingly, the charging voltage V2 outputted from the synchronous buck 192 slowly decreases, as shown in FIG. 2.

In this manner, as the driving signal is alternately inputted from the charging controller 193 to the synchronous buck 192, the charging voltage V2 outputted from the synchronous buck 192 has the form of a rectangular wave, similarly to the waveform of the charging voltage in the conventional pulse charging method as shown in FIG. 2. However, unlike the conventional pulse charging method, it is possible to set the target value of the charging voltage V2 supplied to the battery 194 to be equal to a target value of the charging voltage V2 in the CCCV method.

In addition, in the pseudo pulse charging method, the time interval and the period thereof in which the driving signal is outputted and is not outputted from the charging controller 193, that is, a duty ratio of the charging voltage V2 supplied to the battery 194, may be freely designed. For example, the duty ratio may be set based on of a cell voltage of the battery 194. As shown in FIG. 4, the microcomputer 195 may set the duty ratio of the charging voltage V2 by setting a pulse charging frequency based on information inputted externally.

The microcomputer 195 may control the charging controller 193 so that the battery 194 can be charged according to the pseudo pulse charging method when the charging voltage V2 reaches the predetermined target value. The microcomputer 195 may control the charging controller 193 so that the battery 194 can be charged in the CC mode according to the CCCV method until the charging voltage V2 reaches the predetermined target value, and then charged according to the pseudo pulse charging method when the charging voltage V2 reaches the predetermined target value, that is, when the charging process enters the CV mode.

As a result of monitoring the charging voltage V2, when the charging voltage V2 reaches the predetermined target value, the charging controller 193 may transmit mode information to the microcomputer 195 indicating that the charging process is entering the CV mode. Upon receiving the mode information from the charging controller 193, the microcomputer 195 controls the charging controller 193 to charge the battery 194 according to the pseudo pulse charging method.

If charged level of the battery reaches more than a predetermined value, the microcomputer 195 controls the charging controller 193 to stop the charging operation. For example, if the charged level of the battery 194 reaches 99% of the full capacity of the battery 194, the charging operation may be stopped. The microcomputer 195 may receive information on the battery charged level from the charging controller 193 and control the charging controller 193 based on the received information. The microcomputer 195 may control the charging controller 193 to stop the charging operation by applying the DISABLE signal to the signal input pin CHGEN of the charging controller 193.

Since the capacitor C is provided at an output stage of the synchronous buck 192, as shown in FIG. 4, the charging voltage V2 neither drops nor rises abruptly even when the driving signal of the charging controller 193 is suspended or restarts. Accordingly, by controlling only the operation of the charging controller 193 to perform the pseudo pulse charging method, and not by a switching device (such as a MOSFET), no voltage overshoot occurs. As a result, the computer system 100 of the present invention is capable of improving circuit stability and preventing deterioration of battery durability.

In addition, when the charging operation is performed in the pseudo pulse charging method, since the duty ratio of the charging voltage can be freely adjusted without the charging voltage depending on a voltage of the battery cell, it is possible to design a battery charging method dynamically.

According to another example embodiment of the present invention, the microcomputer 195 may control the charging controller 193 to charge the battery 194 according to the CCCV method when the microcomputer 195 enters the CV mode, not the pseudo pulse charging method, under an instruction from a user. The instruction from the user may be inputted through one of the peripherals 160, such as a keyboard and/or a mouse. For example, when a particular key of the keyboard is pushed, the microcomputer 195 may determine that one of the CCCV method and the pseudo pulse charging method is selected. The microcomputer 195 may have an ENABLE state in which the microcomputer 195 operates in the pseudo pulse charging method after entering the CV mode and a DISABLE state in which the microcomputer 195 operates in the CCCV method after entering the CV mode, depending on external pulse charging ENABLE/DISABLE signals. The microcomputer 195 is provided as an example of a controller.

Since the charging voltage in the CCCV method has the same level as that in the pseudo pulse charging method, these two methods may be freely exchanged with each other according to the situation. Accordingly, the battery can be efficiently charged and user's convenience can be improved.

FIG. 6 is a flow chart showing a charging process of the battery 194 in the computer system 100 according to an example embodiment of the invention. At block S101, if the battery 194 is to be charged, the microcomputer 195 transmits an ENABLE signal to the signal input pin CHGEN of the charging controller 193 to control the charging controller 193 to output a driving signal. Upon receiving the ENABLE signal from the microcomputer 195, the charging controller 193 continues to output the driving signal to drive the synchronous buck 192 so that the charging voltage V2 of the synchronous buck 192 can reach a predetermined target value. The charging controller 193 drives the synchronous buck 192 so that the battery 194 can be charged according to the CCCV method.

At block S102, the charging controller 193 monitors the charging voltage V2 to determine whether the charging voltage V2 reaches the predetermined target value, that is, whether the charging process enters a CV mode. If the charging process has not entered the CV mode, the charging controller 193 continues to output the driving signal to perform the charging process at block S102.

If the charging process has entered the CV mode, the charging controller 193 transmits mode information indicating this entrance to the microcomputer 195. Upon receiving the mode information indicating the entrance into the CV mode from the charging controller 193, the microcomputer 195 alternately transmits the ENABLE signal and the DISABLE signal to the signal input pin CHGEN of the charging controller 193 at block S103. Accordingly, the charging controller 193 alternates the driving signal between supply and suspension.

At block S104, the microcomputer 195 determines whether or not the charging of the battery 194 has been completed. If the charging of the battery 194 has not been completed, the charging process returns to block S103 where the charging controller 193 alternates the driving signal between supply and suspension. If the charging of the battery 194 has been completed, the microcomputer 195 transmits the DISABLE signal to the signal input pin CHGEN of the charging controller 193. Accordingly, the charging controller 193 ends the charging process by stopping the driving signal.

According to another example embodiment, if the user selects the CCCV method before completion of blocks S101 to S105, the microcomputer 195 transmits the ENABLE signal to the signal input pin CHGEN of the charging controller 193 so that the charging controller can continue to output the driving signal to maintain the CCCV method.

As apparent from the above description, according to aspects of the present invention, by controlling only the operation of the converter driver to perform the pseudo pulse charging method without switching a power supply path, no voltage overshoot occurs. Accordingly, the computer system is capable of improving circuit stability and preventing battery durability from being deteriorated.

In addition, according to another aspect of the present invention, when the charging operation is performed in the pseudo pulse charging method, since the duty ratio of the charging voltage can be freely adjusted without the charging voltage depending on a voltage of the battery cell, it is possible to design a battery charging method dynamically.

Further, according to another aspect the present invention, since the charging voltage in the CCCV method has the same level as that in the pseudo pulse charging method, these two methods may be freely exchanged with each other according to the situation. Accordingly, the battery can be efficiently charged and user's convenience can be improved.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the functionality of the microcomputer may be incorporated into the charging controller. The power supply unit is not limited for use in computing devices but may be incorporated into any device having an auxiliary power source needing a charging voltage. Accordingly, it is intended, therefore, that the present invention not be limited to the various example embodiments disclosed, but that the present invention includes all embodiments falling within the scope of the appended claims.

What is claimed is:

1. A power supply apparatus comprising:
a converter to convert a level of an input voltage into a charging voltage and to output the charging voltage to a battery unit;
a converter driving unit to output a driving signal to the converter so that the charging voltage outputted from the converter is able to reach a predetermined target value; and
a controller to control the converter driving unit to alternate the driving signal between supplying the charging voltage and suspension of the charging voltage.

2. The power supply apparatus according to claim 1, wherein the controller controls the converter driving unit to alternate the driving signal between supplying and suspension after the charging voltage of the battery unit has reached the predetermined target value.

3. The power supply apparatus according to claim 1, wherein:
the converter converts a level of an input direct current (DC) voltage according to a switch-mode method; and
the driving signal of the converter driving unit comprises a Pulse Width Modulation (PWM) signal.

4. The power supply apparatus according to claim 1, wherein the converter driving unit and the controller are integrally formed.

5. The power supply apparatus according to claim 1, wherein the charging voltage outputted from the converter has the same level as a cell voltage of the battery unit.

6. The power supply apparatus according to claim 1, wherein the controller selectively performs a first control operation to alternate the driving signal between supplying and suspension and a second control operation to maintain output of the driving signal.

7. The power supply apparatus according to claim 6, further comprising a user input unit to input an instruction from a user, wherein one of the first control operation and the second control operation is determined according to the instruction from the user.

8. The power supply apparatus according to claim 1, wherein the battery unit is provided in a computer system.

9. A control method of a computer system comprising a converter to convert a level of an input voltage and outputs a charging voltage of a battery unit that supplies power to the computer system, and a converter driving unit to output a driving signal to the converter so that the charging voltage outputted from the converter is able to reach a predetermined target value, the control method comprising:
alternating the driving signal output by the converter driving unit between supplying the charging voltage and suspension of the charging voltage.

10. The control method according to claim 9, wherein the driving signal is alternated after the charging voltage of the battery unit has reached the predetermined target value.

11. The control method according to claim 9, wherein:
the converter converts a level of an input direct current (DC) voltage according to a switch-mode method; and
the driving signal of the converter driving unit comprises a Pulse Width Modulation (PWM) signal.

12. The control method according to claim 9, wherein the charging voltage outputted from the converter has the same level as a cell voltage of the battery unit.

13. The control method according to claim 9, wherein the driving signal is alternated by selectively performing a first control operation to alternate the driving signal between supply and suspension and a second control operation to maintain output of the driving signal.

14. The control method according to claim 13, wherein the selectively performing the first control operation and the second control operation comprises:
receiving an instruction from a user; and
selecting one of the first control operation and the second control operation according to the instruction from the user.

15. A power supply unit comprising:
a battery unit;
a converter to convert an input voltage into a charging voltage and to supply the charging voltage to the battery unit;
a converter driving unit to transmit a driving signal to the converter to control the operation of the converter to switch between a constant current constant voltage (CCCV) charging mode and a pseudo pulse charging mode.

16. The power supply unit according to claim 15, wherein the CCCV mode is a mode in which the converter driving unit transmits the driving signal to the converter until the charging voltage reaches a predetermined target value, and then controls the converter to maintain the charging voltage at the predetermined target value.

17. The power supply according to claim 16, wherein, after the charging voltage reaches the predetermined value, the converter driving unit transmits the driving signal so as to alternate between supplying the charging voltage and not supplying the charging value.

18. The power supply according to claim 15, wherein the converter driving unit transmits the driving signal based on input from a user.

19. The power supply according to claim 15, wherein the pseudo pulse charging mode is a mode wherein the converter driving unit transmits the driving signal to the converter so as to control the converter to alternate between supplying the charging voltage to the battery unit and not supplying the charging voltage to the battery unit.

20. The power supply according to claim 15, further comprising a controller to control the converter driving unit.

21. A method of controlling the charging of a battery unit, the method comprising:
transmitting a charging voltage to the battery unit until a predetermined target value is reached; and
alternating between supplying the charging voltage and not supplying the charging voltage after the predetermined target is reached, until charging of the battery is complete.

22. The method of claim 21, wherein the charging voltage is transmitted to the battery unit based on a driving signal.
